(19) United States
(12) Patent Application Publication
(10) Pub. No.: US 2018/0281436 A1
(43) Pub. Date: Oct. 4, 2018

(54) LIQUID DISCHARGE APPARATUS

(71) Applicant: BROTHER KOGYO KABUSHIKI KAISHA, Nagoya-shi (JP)

(72) Inventor: Shogo MORI, Nagoya-shi (JP)

(73) Assignee: BROTHER KOGYO KABUSHIKI KAISHA, Nagoya-shi (JP)

(21) Appl. No.: 15/851,349

(22) Filed: Dec. 21, 2017

(30) Foreign Application Priority Data
Mar. 31, 2017 (JP) 2017-073002

(51) Int. Cl. B41J 2/175; B41J 2/14

(52) U.S. Cl. CPC B41J 2/17556; B41J 2/04; B41J 2/14233

(57) ABSTRACT

A liquid discharge apparatus includes a plate-like actuator including a plurality of individual electrodes aligning in a first direction, a channel member being joined to one surface of the actuator to include a plurality of pressure chambers aligning along the first direction, and a heater being arranged directly or indirectly on the other surface of the actuator and having a convex portion in direct or indirect contact with the plate-like actuator. The convex portion is arranged between the plurality of individual electrodes and an outer edge of the actuator.

### CROSS REFERENCE TO RELATED APPLICATION

The present application claims priority from Japanese Patent Application No. 2017-073002 filed on Mar. 31, 2017, the disclosures of which is incorporated herein by reference in its entirety.

### BACKGROUND

### Field of the Invention

The present disclosure relates to liquid discharge apparatuses configured to discharge liquid such as an ink.

### Description of the Related Art

Conventionally, there are disclosed liquid droplet jet apparatuses including a channel unit in which ink flow channels are formed to communicate with a plurality of nozzles, a pressure application device for causing a liquid to be jetted from the nozzles, and a wiring substrate outputting a drive signal to the pressure application device. The liquid droplet apparatuses form image by jetting an ink from the nozzles onto a recording medium such as paper.

### SUMMARY

If the viscosity of the ink depends on temperature and when the temperature decreases, then it becomes difficult for the ink to be jetted from the nozzles. Therefore, a heater may be provided for the channel unit to prevent the ink from decreasing in temperature.

However, even if the heater is provided, the channel unit is still liable to easily cooling down in its peripheral portion so as to bring about uneven temperature of the ink flowing inside the channel unit. In such a case, variation occurs in the viscosity of the ink jetted from the respective nozzles, thereby bringing about decrease in image quality.

The present disclosure is made in view of the above situation, and an object thereof is to provide a liquid discharge apparatus capable of uniformizing the liquid temperature to restrain the image quality from decrease.

According to an aspect of the present disclosure, there is provided a liquid discharge apparatus including: a plate-like actuator including a plurality of individual electrodes aligning in a first direction; a channel member joined to one surface of the actuator and including a plurality of pressure chambers aligning in the first direction; and a heater arranged directly or indirectly on the other surface of the actuator and including a convex portion in direct or indirect contact with the plate-like actuator. The convex portion is arranged between the plurality of individual electrodes and an outer edge of the actuator.

Being close to the external air, the periphery of the channel member is easier to cool than the center. Because the convex portion is arranged between the plurality of individual electrodes and an outer edge of the actuator, a large amount of heat is supplied to the part of the actuator being easy to cool, such that the heat transfers therefrom to the center of the channel member. Therefore, it is possible to uniformize the temperature of the channel member; thus, it is possible to uniformize the ink temperature, thereby restraining the image quality from decreasing.

### BRIEF DESCRIPTION OF THE DRAWINGS

FIG. 1 is a plan view schematically depicting a printer according to a first embodiment of the present disclosure;

FIG. 2 is a plan view schematically depicting an ink jet head;

FIG. 3 is an exploded perspective view schematically depicting a liquid discharge apparatus;

FIG. 4 is a vertical cross-sectional view schematically depicting the liquid discharge apparatus;

FIG. 5 is a partially enlarged vertical cross-sectional view schematically depicting the liquid discharge apparatus;

FIG. 6 is a partially enlarged cross-sectional view schematically depicting an actuator and a channel member;

FIG. 7 is an exploded perspective view schematically depicting a heater;

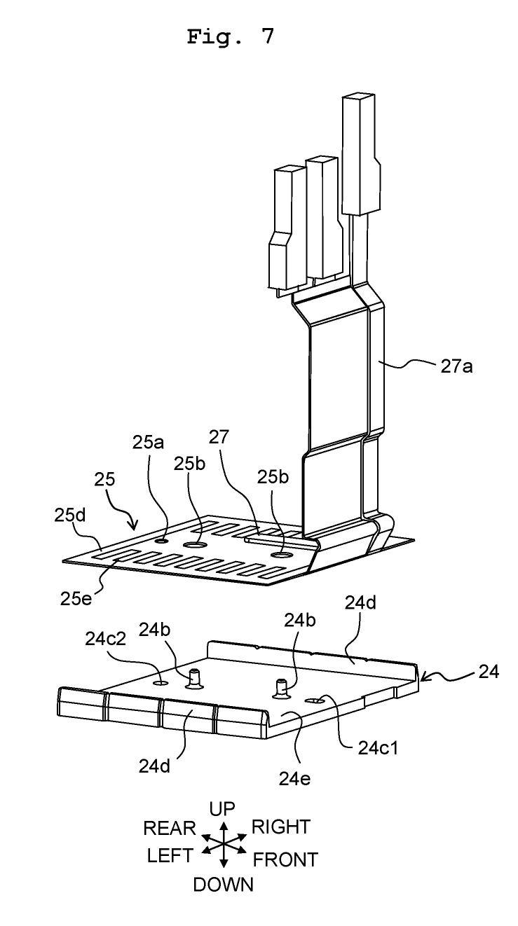

FIG. 8 is a bottom view schematically depicting a body;

FIG. 9 is a schematic plan view schematically depicting a convex portion, the actuator, and the channel member;

FIG. 10 is a bottom view schematically depicting a body according to a first modification having changed part of the configuration of the first embodiment;

FIG. 11 is a bottom view schematically depicting a body according to a second modification having changed part of the configuration of the first embodiment;

FIG. 12 is a schematic plan view schematically depicting a convex portion, an actuator, and a channel member according to a third modification having changed part of the configuration of the first embodiment;

FIG. 13 is a bottom view schematically depicting a body according to a second embodiment of the present disclosure; and

FIG. 14 is a schematic plan view schematically depicting a first convex portion, a second convex portion, an actuator, and a channel member according to the second embodiment.

### DESCRIPTION OF THE EMBODIMENTS

### First Embodiment

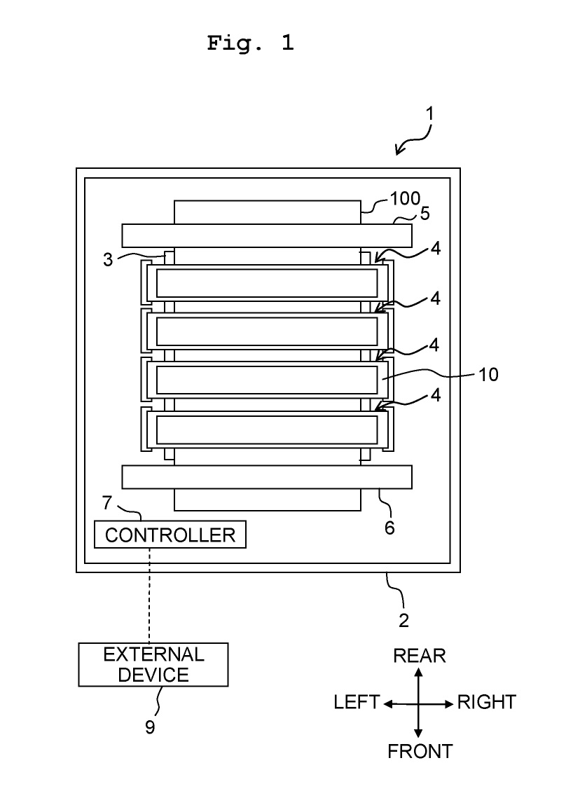

The present disclosure will be explained below based on the accompanying drawings depicting a printer according to a first embodiment. FIG. 1 is a plan view schematically depicting a printer 1. In FIG. 1, a conveyance direction of recording paper 100 (recording medium) corresponds to a front-rear direction of the printer 1. Further, a width direction of the recording paper 100 corresponds to a left-right direction of the printer 1. Further, an direction orthogonal to the front-rear direction and the left-right direction, that is, a direction perpendicular to the page of FIG. 1 corresponds to an up-down direction of the printer 1.

As depicted in FIG. 1, the printer 1 includes a platen 3 contained in a casing 2, four ink jet heads 4, two conveyance rollers 5 and 6, a controller 7, and the like.

The recording paper 100 is carried on the upper surface of the platen 3. The four ink jet heads 4 align in the conveyance direction above the platen 3. Each of the ink jet heads 4 is a so-called line-type head. The ink jet heads 4 are supplied with inks from an unshown ink tank. The four ink jet heads 4 are supplied with the inks in different colors.

As depicted in FIG. 1, the two conveyance rollers 5 and 6 are arranged respectively at the rear side and at the front side of the platen 3. The two conveyance rollers 5 and 6 are driven respectively by an unshown motor to convey the recording paper 100 on the platen 3 frontward.

The controller 7 includes an FPGA (Field Programmable Gate Array), an EEPROM (Electrically Erasable Programmable Read-Only Memory), a RAM (Random Access Memory), and the like. Further, the controller 7 may further include a CPU (Central Processing Unit) or ASIC (Application Specific Integrated Circuit), etc. The controller 7 is connected with an external device 9 such as a PC or the like in a data communicable manner and, based on print data sent from the external device 9, controls every unit of the printer 1.

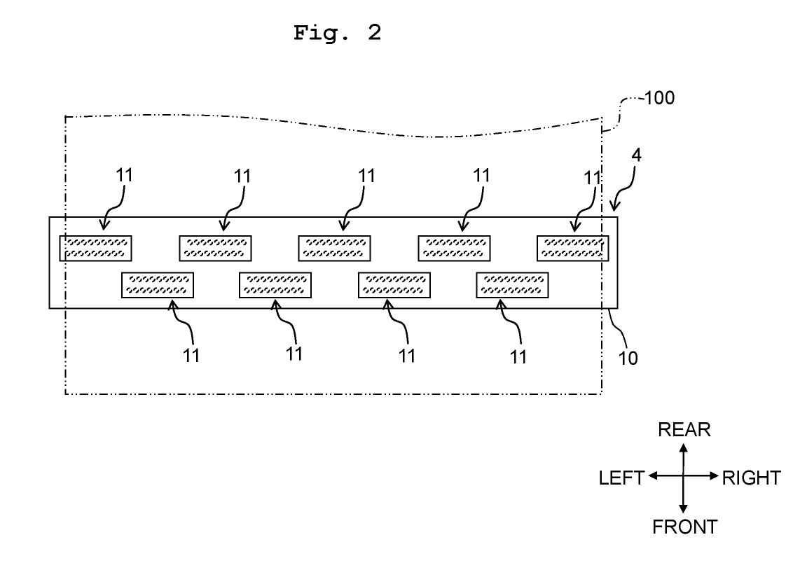

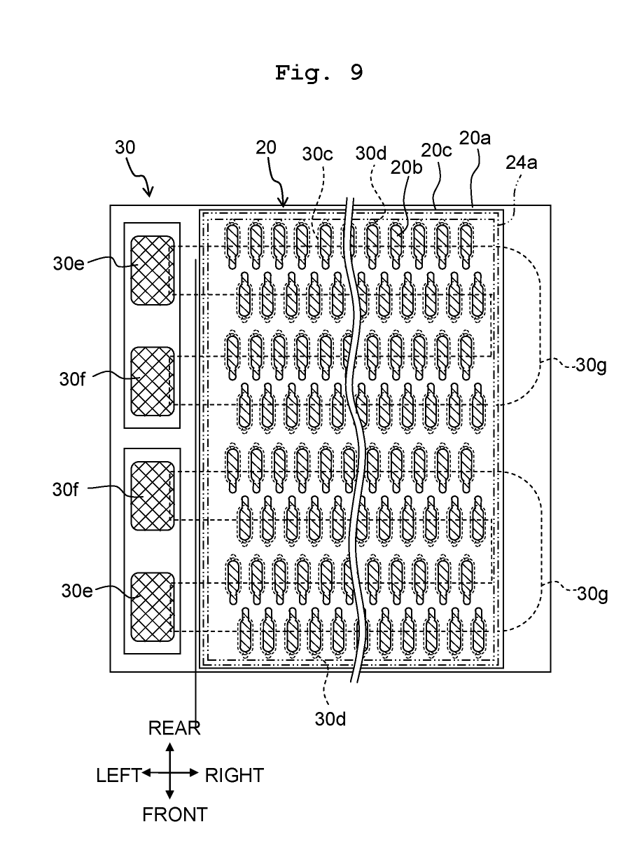

FIG. 2 is a plan view schematically depicting the ink jet head 4. As depicted in FIG. 2, the ink jet head 4 includes a plurality of liquid discharge apparatuses 11. The plurality of liquid discharge apparatuses 11 are fitted on a holder plate 10 in a staggered alignment. Each of the liquid discharge apparatuses 11 has a plurality of nozzles 30d aligning in the left-right direction. Further, because FIG. 2 is a schematic or simplified plan view, the number of nozzle rows is different from that of FIG. 9.

The controller 7 controls the motor for driving the conveyance rollers 5 and 6 to convey the recording paper 100 in the conveyance direction with the two conveyance rollers 5 and 6. Further, along with that, the controller 7 controls the four ink jet heads 4 to jet the inks from the nozzles 30d toward the recording paper 100. By virtue of this, image is printed on the recording paper 100.

Each of the liquid discharge apparatuses 11 includes a first frame 21 having a rectangular shape in planar view. The first frame 21 is provided with an opening 21a at the center. Four through holes 21b align in the front-rear direction to penetrate vertically in a left end portion of the first frame 21.

A heater 28 is provided inside the opening 21a. A plate spring 29 is provided above the heater 28. The plate spring 29 is formed with two positioning holes 29a aligning in the front-rear direction. The two positioning holes 29a are formed to correspond to two aftermentioned bosses 24b. A control substrate 31 is provided above the plate spring 29. The plate spring 29 biases the control substrate 31 upward. With the plate spring 29, a space is provided between the heater 28 and the control substrate 31 such that the plate spring 29 functions as the spacer. The heater 28 will be described in detail later on.

A second frame 32 having a rectangular shape in planar view is provided above the first frame 21. An opening 32a corresponding to the opening 21a of the first frame 21 is provided at the center of the second frame 32. A support collar 32c is provided on the inner circumferential surface of the opening 32a to project toward the center of the opening 32a. Four through holes 32b align in the front-rear direction to penetrate vertically, corresponding to the through holes 21b of the first frame 21.

The first frame 21 and the second frame 32 overlap with each other in the up-down direction. The opening 32a of the second frame 32 is arranged above the opening 21a of the first frame 21, while the through holes 32b of the second frame 32 are arranged above the through holes 21b of the first frame 21. A sealing member 33 is provided between the first frame 21 and the second frame 32 to seal the interspace between the first frame 21 and the second frame 32 in a liquid tight manner.

The heater 28 and the control substrate 31 are arranged inside the opening 21a of the first frame 21 and inside the opening 32a of the second frame 32. A holder collar 34 is provided on the support collar 32c of the second frame 32. The support collar 32c supports the holder collar 34. A cooling plate 35 is provided inside the holder collar 34. The holder collar 34 supports the cooling plate 35. An alignment frame 36 is provided above the cooling plate 35 and the second frame 32.

A plate-like channel member 30 is provided below the first frame 21. An actuator 20 is provided on the upper surface of the channel member 30. The actuator 20 is arranged inside the opening 21a.

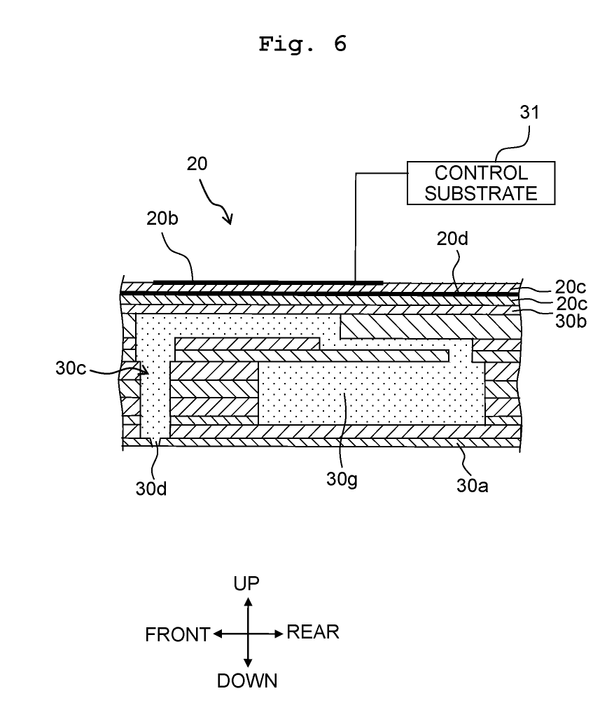

The channel member 30 includes a plurality of plates in which through holes are formed to define flow channels respectively. The channel member 30 includes a nozzle plate 30a and a vibration plate 30b. In the nozzle plate 30a, the plurality of nozzles 30d align in the left-right direction (the direction perpendicular to the page of FIG. 6). A pressure chamber 30c is formed above each of the plurality of nozzles 30d. The pressure chambers 30c are linked to an aftermentioned common flow channel 30g.

The actuator 20 is arranged on the vibration plate 30b. The vibration plate 30b is provided above the pressure chambers 30c to block the top openings of the pressure chambers 30c. Two piezoelectric layers 20c are stacked in the actuator 20. A common electrode 20d is provided between the two piezoelectric layers 20c. The common electrode 20d is constantly kept at the ground potential. The actuator includes a plurality of individual electrodes 20b aligning in the left-right direction (the first direction). The plurality of individual electrodes 20b are provided on the upper piezoelectric layer 20c and arranged respectively above the plurality of pressure chambers 30c. The plurality of individual electrodes 20b are connected respectively with the control substrate 31.

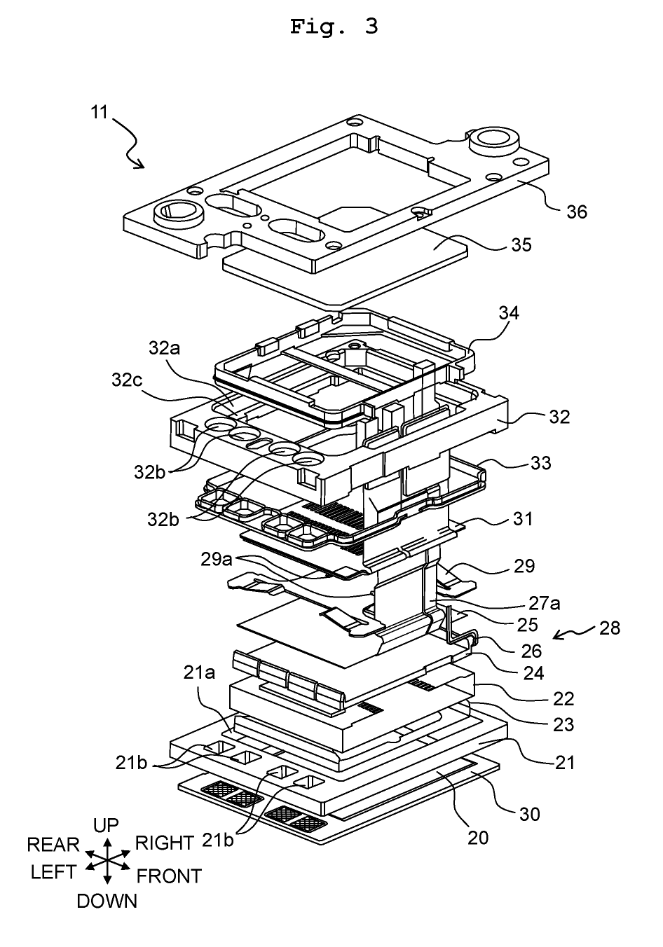

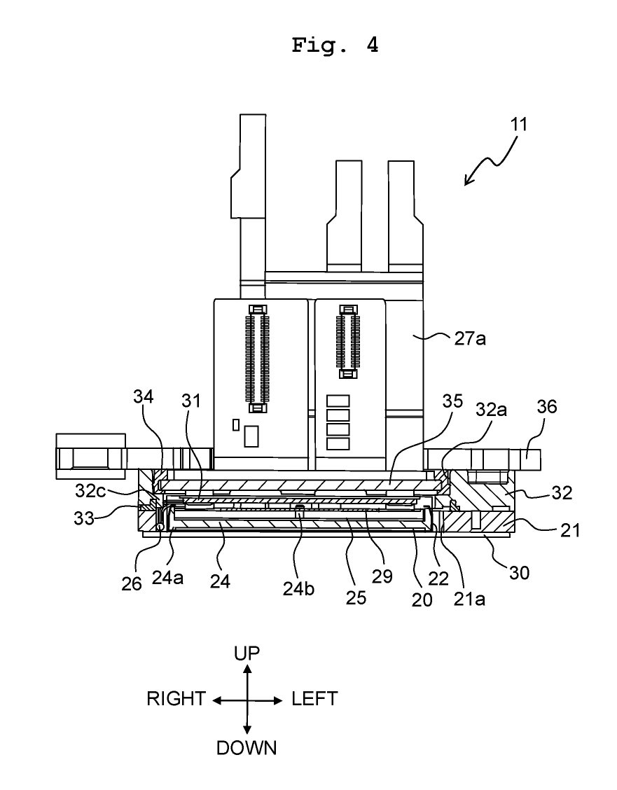

As depicted in FIGS. 3 and 4, a COF 22 is joined on the upper surface of the actuator 20 via a junction member 23 having a circular shape in planar view. The junction member 23 may be a double-stick tape, a sheet-like adhesive, or the like. A plurality of contact points are formed on the upper surface of the actuator 20 to correspond to the individual electrodes and to the common electrode.

Those plurality of contact points formed on the upper surface of the actuator 20 are joined respectively with a plurality of contact points provided on the COF 22 by using bumps. The heater 28 is provided on the upper surface of the COF 22. The COF 22 is wider than the heater 28 along the left-right direction, and a left end portion and a right end portion of the COF 22 are flexed upward to cover a left end portion and a right end portion of the upper surface of the heater 28.

The heater 28 includes a plate-like body 24, and a film heater 25. The liquid discharge apparatus 11 includes a first thermistor 26 and a second thermistor 27. The body 24 includes a plate portion 24e, and projecting portions 24d are formed respectively of a left edge portion and a right edge portion of plate portion 24e to project upward. Through holes 24c1 and 24c2 are formed to penetrate vertically in a front edge portion and a rear edge portion of the plate portion 24e, respectively.

The through hole 24c1 is a long hole extending in the front-rear direction while the through hole 24c2 is a circular hole. The through holes 24c1 and 24c2 are arranged in a central portion of the plate portion 24e according to the left-right direction. The two through holes 24c1 and 24c2 are used for positioning the body 24 to a jig in a process of attaching the junction member 23 to the body 24. The two bosses 24b align in the front-rear direction between the two through holes 24c1 and 24c2. The bosses 24b project upward from the plate portion 24e.

The film heater 25 includes a film portion 25d. The film portion 25d is formed of a resin such as polyimide or the like. The film portion 25d is formed with two through holes 25b penetrating vertically to correspond to the two bosses 24b. Further, the film portion 25d is provided with a flow-through hole 25a for the air to flow therethrough, corresponding to the through hole 24c2 formed in the rear edge portion of the plate portion 24e. Further, the film portion 25d is formed with a heating wire 25e. The second thermistor 27 is provided on the upper surface of the film portion 25d. The second thermistor 27 is capable of measuring the temperature of the film portion 25d. The second thermistor 27 is connected with the controller 7 via a wiring part 27a.

The film heater 25 is provided on the upper surface of the body 24. The two bosses 24b are inserted respectively into the two through holes 25b to project upward from the film portion 25d and be inserted into two positioning holes 29a of the plate spring 29. By inserting the bosses 24b into the positioning holes 29a, the position of the plate spring 29 is determined in the front-rear direction and in the left-right direction.

The flow-through hole 25a is arranged above the through hole 24c2 such that the through hole 24c2 is not blocked by the film portion 25d. Therefore, the air can flow through the flow-through hole 25a and the through hole 24c2. On the other hand, the through hole 24c1 is blocked by the film portion 25d. The heating wire 25e is not arranged in such a part of the film portion 25d as positioned above the through hole 24c1. Even if the heating wire 25e is arranged in the part of the film portion 25d positioned above the through hole 24c1, that is, the part of the film portion 25d blocking the opening of the through hole 24c1, it is still not possible for the heat produced in that part to transfer to the body 24. Because the heating wire 25e is not arranged in the part of the film portion 25d positioned above the through hole 24c1, it is possible to prevent the electric power from uneconomical consumption.

The first thermistor 26 is arranged on the upper surface of the channel member 30 to detect the temperature of the channel member 30. The first thermistor 26 is connected with the controller 7. Based on the temperature detected by the first thermistor 26 and the second thermistor 27, the controller 7 controls the supply current to the heating wire 25e.

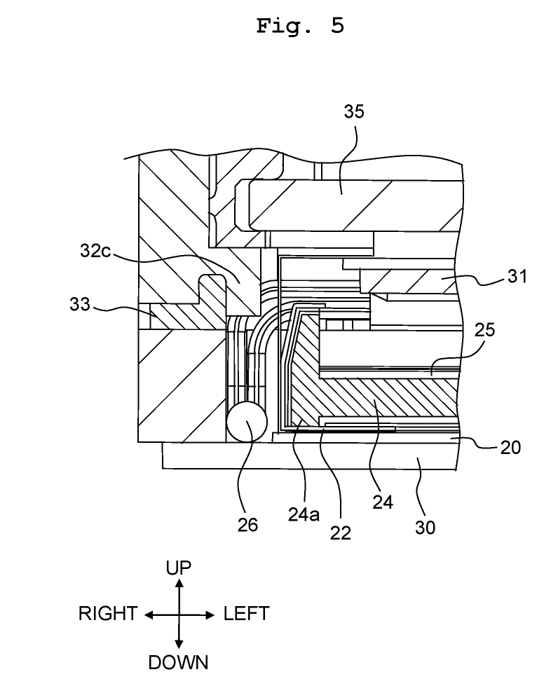

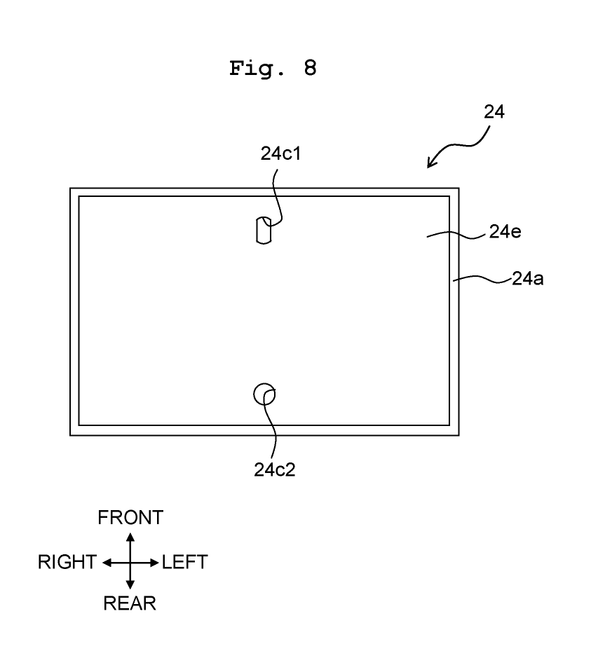

As depicted in FIGS. 5 and 8, an annular convex portion 24a is provided to project downward in a circumferential portion of the bottom of the body 24. As depicted in FIG. 9, via the COF 22, the convex portion 24a is in contact with a circumferential part of the plurality of individual electrodes 20b on the upper surface of the actuator 20. Via the COF 22, the convex portion 24a is in contact with a circumferential part of the upper surface of the actuator 20. In other words, the convex portion 24a is arranged between the plurality of individual electrodes 20b and the outer edge of the channel member 30.

The aforementioned annular junction member 23 is arranged right below the convex portion 24a, and the convex portion 24a is attached to the COF 22 with the junction member 23. A reinforcement bump is formed in such a part of the COF 22 as pressed by the convex portion 24a, to fix the actuator 20 and the COF 22.

The channel member 30 includes two supply ports 30e supplied with the liquid. The two supply ports 30e align in the front-rear direction in a left edge portion of the channel member 30. In the left edge portion of the channel member 30, two discharge ports 30f align in the front-rear direction to discharge the liquid between the two supply ports 30e.

One of the supply ports 30e is linked to the one discharge port 30f adjacent to that supply port 30e through the common flow channel 30g having a U-shape in planar view. The common flow channel 30g is formed inside the channel member 30 to link to the respective pressure chambers 30c.

Further, the other supply port 30e is linked to the other discharge port 30f adjacent to that supply port 30e through another common flow channel 30g having a U-shape in planar view. The common flow channel 30g is also formed inside the channel member 30 to link to the respective pressure chambers 30c.

The ink supplied from the ink tank to the supply ports 30e passes through the common channels 30g to reach the pressure chambers 30c. The controller 7 applies a voltage between the common electrode 20d and the individual electrodes 20b to drive the piezoelectric layer 20c so as to vibrate the vibration plate 30b. Due to the vibration of the vibration plate 30b, a positive pressure is produced inside the pressure chambers 30c to jet the ink from the nozzles 30d, and a negative pressure is produced inside the pressure chambers 30c to supply the ink from the common channels 30g to the pressure chambers 30c.

The ink not supplied to the pressure chambers 30c passes through the common channels 30g and moves along a front edge portion or a rear edge portion of the channel member 30. Thereafter, it makes a U-turn in a right edge portion and moves through a central portion of the channel member 30 according to the front-rear direction to reach the discharge ports 30f. The ink discharged from the discharge ports 30f returns into the ink tank to be supplied again to the supply ports 30e.

The ink undergoes a decrease in temperature during the passage through the common channels 30g. Therefore, the controller 7 applies an electric current to the heating wire 25e to heat the body 24. The heat in the body 24 transfers to a circumferential portion of the channel member 30 via the convex portion 24a, and transfers from the circumferential portion to a central portion of the channel member 30, such that the whole of the channel member 30 is heated.

Being close to the external air, the periphery of the channel member 30 is easier to cool than the center. Because the convex portion 24a is in contact with the periphery of the actuator 20, the largest amount of heat is supplied to the periphery of the actuator 20 being easy to cool, such that the heat transfers therefrom to the periphery and center of the channel member 30. Therefore, it is possible to uniformize the temperature of the channel member 30; thus, it is possible to uniformize the ink temperature, thereby restraining the image quality from decreasing.

Further, the convex portion 24a is not in contact with the part of the actuator 20 where the plurality of individual electrodes are arrayed. Therefore, the body 24 does not bring about adverse effects such as impeding the actuator 20 from piezoelectric deformation, impeding the liquid from being jetted, and the like.

The film portion 25d blocks the through hole 24c1 of the body 24, but the heating wire 25e is not arranged on the film portion 25d positioned above the through hole 24c1. Therefore, it is possible to facilitate the heat release from the through hole 24c1 for the body 24, thereby preventing the body 24 from overheat.

The flow-through hole 25a of the film portion 25d is arranged over the through hole 24c2 of the body 24 such that the film portion 25d does not block the through hole 24c2. Therefore, it is possible to let the air flow through the flow-through hole 25a and the through hole 24c2. If the space enclosed by the body 24 and the COF 22 is tightly sealed, then the pressure inside the tightly sealed space increases due to the heat generation of the film heater 25, such that the liquid discharge apparatuses 11 are liable to damage because of detachment or the like between the plurality of relevant components. With the structure capable of letting the air flow therethrough via the flow-through hole 25a and the through hole 24c2, it is possible to prevent the liquid discharge apparatuses 11 from damage. Further, the film portion 25d may be formed with a flow-through hole corresponding to the through hole 24c1, to further improve the air permeability.

By providing the plate spring 29 between the heater 28 and the control substrate 31, a space is formed between the heater 28 and the control substrate 31. Therefore, it is possible to prevent the control substrate 31 from overheat. Further, with the plate spring 29 blocking the radiation from the heater 28, it is possible to prevent the control substrate 31 from being overheated by the radiation heat from the heater 28.

The junction member 23 is arranged right below the convex portion 24a such that the convex portion 24a presses the COF 22 on the second frame 32. With the part of the COF 22 pressed by the convex portion 24a as the fulcrum, it is possible to easily bend up the left end portion and the right end portion of the COF 22.

<Modifications>

In the first embodiment as described above, the convex portion 24a is in contact with the circumferential part of the plurality of individual electrodes 20b on the upper surface of the actuator 20, via the COF 22. However, present teaching is not limited to such structures. For example, the convex portion 24a may be directly in contact with the circumferential part of the plurality of individual electrodes 20b on the upper surface of the actuator 20. Alternatively, the convex portion 24a may be in contact with the circumferential part of the plurality of individual electrodes 20b on the upper surface of the actuator 20, via the heat-transfer member having a high heat transfer rate, such as thermal grease. In other words, the convex portion 24a may be indirectly in contact with the upper surface of the actuator 20 via the heat-transfer member.

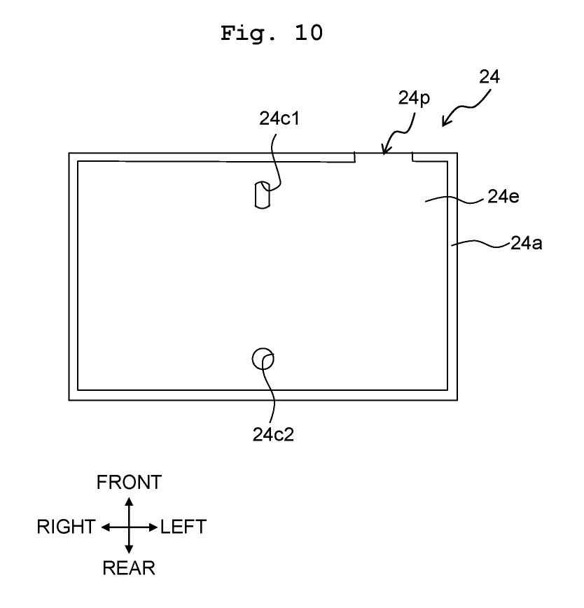

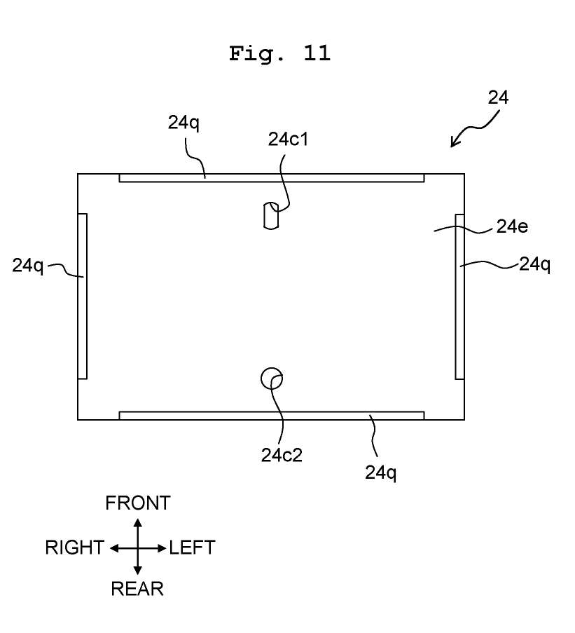

As depicted in FIG. 10, a notch or an opening 24p may be provided in part of the convex portion 24a. With the notch or opening 24p, it is possible to improve the air permeability. Further, the convex portion 24a is not limited to a single member. As depicted in FIG. 11, for example, a plurality of convex portions 24q may be provided. In this case, too, the plurality of convex portions 24q may be arranged at the outer edge side of the channel member 30 than the plurality of individual electrodes 20b such that, for example, the plurality of convex portions 24q may be arranged intermittently around the plurality of individual electrodes 20b or arranged at least in one of a front edge portion, a rear edge portion, a right edge portion, and a left edge portion of the upper surface of the channel member 30.

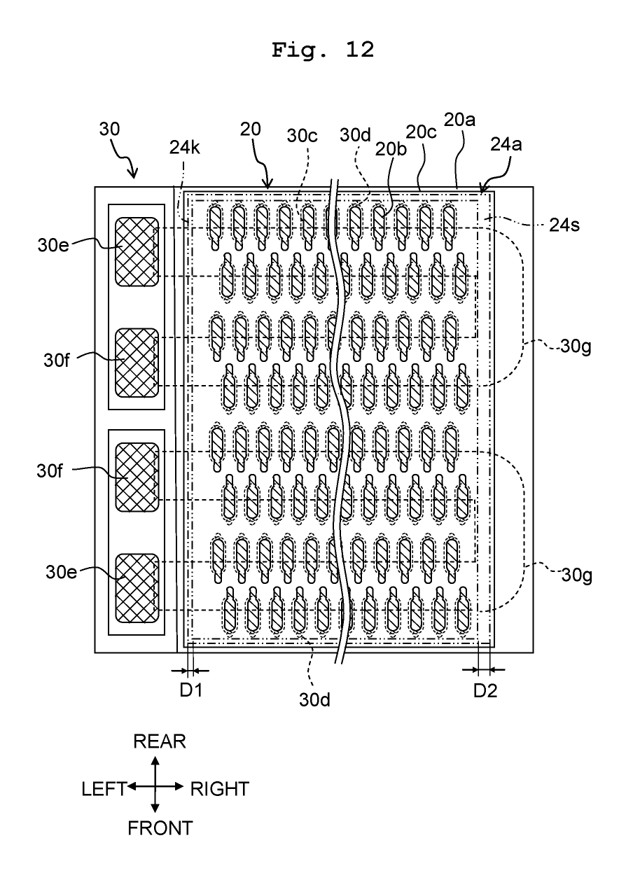

Further, as depicted in FIG. 12, the convex portion 24a may include a left-side part 24k (to be referred to below as a first part) and a right-side part 24s (to be referred to below as a second part) which are different in the width from left to right. In particular, the first part 24k is arranged between the supply ports 30e and the discharge ports 30f, and a second convex portion 124b, and the second part 24s has a left-right width D2 which is larger than a left-right width D1 of the first part 24k.

The ink in parts away from the supply ports 30e is cooled to a lower temperature during flowing through the common channels 30g, and thus decreases more easily in temperature than the ink in the vicinity of the supply ports 30e. In the modification depicted in FIG. 12, the width D2 of the second part 24s away from the supply ports 30e is larger than the width D1 of the first part 24k, such that the second part 24s has a larger area in contact with the channel member 30 than the first part 24k. Hence, more amount of heat transfers to parts of the channel member 30 away from the supply ports 30e such that it is possible to uniformize the ink temperature, thereby restraining the image quality from decreasing.

### Second Embodiment

The present disclosure will be explained below based on the accompanied drawings depicting a printer according to a second embodiment.

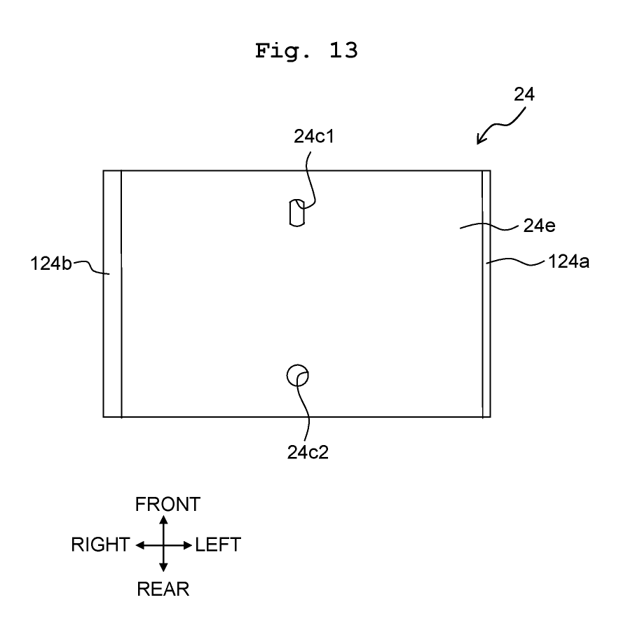

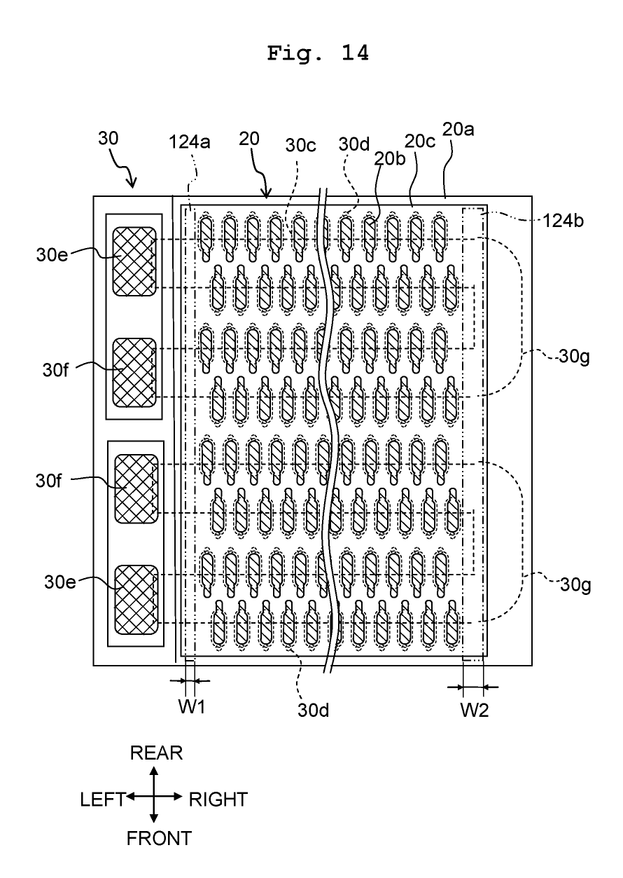

As depicted in FIG. 13, a first convex portion 124a is provided in a left edge portion of the bottom of the body 24 to extend in the front-rear direction (the second direction) and project downward. Further, a second convex portion 124b is provided in a right edge portion of the bottom of the body 24 to extend in the front-rear direction and project downward. The first convex portion 124a and the second convex portion 124b stand away from each other in the left-right direction (the first direction). As depicted in FIG. 14, in the left-right direction, the first convex portion 124a is arranged between the supply ports 30e and discharge ports 30f, and the second convex portion 124b. The first convex portion 124a is arranged in the vicinity of the supply ports 30e, while the second convex portion 124b stands away from the supply ports 30e. The second convex portion 124b has a width W2 which is larger than a width W1 of the first convex portion 124a, along the left-right direction.

The ink in parts away from the supply ports 30e is cooled to a lower temperature during flowing through the common channels 30g, and thus decreases more easily in temperature than the ink in the vicinity of the supply ports 30e. In the second embodiment, the width W2 of the second convex portion 124b away from the supply ports 30e is larger than the width W1 of the first convex portion 124a, such that the second convex portion 124b has a larger area in contact with the channel member 30 than the first convex portion 124a. Hence, more amount of heat transfers to parts of the channel member 30 away from the supply ports 30e such that it is possible to uniformize the ink temperature, thereby restraining the image quality from decreasing.

It should be understood that the embodiments disclosed above are exemplary but not limitary in each and every aspect. It is possible to combine the technical characteristics described in the respective embodiments with one another. The scope of the present invention is intended to include all scopes equivalent to those of the appended claims, and all changes without departing from the true spirit and scope of the present invention.

What is claimed is:

1. A liquid discharge apparatus comprising:
an actuator including a plurality of individual electrodes aligning in a first direction;
a channel member joined to one surface of the actuator and including a plurality of pressure chambers aligning in the first direction; and
a heater arranged directly or indirectly on the other surface of the actuator and including a convex portion in direct or indirect contact with the plate-like actuator,
wherein the convex portion is arranged between the plurality of individual electrodes and an outer edge of the actuator.

2. The liquid discharge apparatus according to claim 1, wherein the convex portion is located at the periphery of the plurality of individual electrodes.

3. The liquid discharge apparatus according to claim 1,
wherein the heater includes a body arranged above the actuator, and a film heater fitted on the body; and
wherein the convex portion projects from the body toward the actuator.

4. The liquid discharge apparatus according to claim 3,
wherein a through hole is provided in the body, and
wherein the film heater is arranged in a position without overlap with the through hole.

5. The liquid discharge apparatus according to claim 3,
wherein a through hole is provided in the body, and
wherein the film heater is provided with a second through hole in communication with the through hole.

6. The liquid discharge apparatus according to claim 3,
wherein a through hole is provided in the body,
wherein the film heater has a part blocking the through hole, and
wherein a heating wire of the film heater is not arranged in the part blocking the through hole.

7. The liquid discharge apparatus according to claim 3,
wherein a first through hole and a second through hole are provided in the body,
wherein the film heater is provided with a third through hole in communication with the first through hole, and
wherein the film heater includes a part blocking the second through hole.

8. The liquid discharge apparatus according to claim 7, wherein a heating wire of the film heater is not arranged in the part blocking the second through hole.

9. The liquid discharge apparatus according to claim 1,
wherein the channel member includes a common channel configured to supply a liquid to the plurality of pressure chambers, and a supply port configured to supply the liquid to the common flow channel;
wherein the convex portion includes a first part and a second part which stand away from each other in the first direction, the first part being arranged between the supply port and the second part in the first direction.

10. The liquid discharge apparatus according to claim 9,
wherein the first part extends in a second direction parallel to the actuator and orthogonal to the first direction, the second part extends in the second direction, and
wherein a width of the second part in the first direction is larger than a width of the first part in the first direction.

11. The liquid discharge apparatus according to claim 1, furthering comprising: a control substrate arranged above the heater to control the drive of the actuator; and a spacer arranged between the heater and the control substrate.

12. The liquid discharge apparatus according to claim 1,
wherein a flexible substrate is located between the heater and the actuator, and a junction member is located below the convex portion to join the flexible substrate and the actuator.

13. A liquid discharge apparatus comprising:
an actuator including a plurality of individual electrodes aligning in a first direction;
a channel member joined to one surface of the actuator and including a plurality of pressure chambers aligning in the first direction; and
a heater arranged directly or indirectly on the other surface of the actuator,
wherein the heater includes a first convex portion in direct or indirect contact with the actuator, and a second convex portion in direct or indirect contact with the actuator; and
wherein the plurality of individual electrodes are arranged between the first convex portion and the second convex portion in the first direction.

14. The liquid discharge apparatus according to claim 13,
wherein the channel member includes: a common channel configured to supply liquid to the plurality of pressure chambers; and a supply port configured to supply the liquid to the common channel, and
wherein the first convex portion is arranged between the supply port and the second convex portion along the first direction.

15. The liquid discharge apparatus according to claim 13,
wherein the first convex portion extends in a third direction orthogonal to the first direction and the second direction,
wherein the second convex portion extends in the third direction, and
wherein a width of the second convex portion in the first direction is larger than a width of the first convex portion in the first direction.
